(19) United States
(12) Patent Application Publication
(10) Pub. No.: US 2009/0026654 A1
(43) Pub. Date: Jan. 29, 2009

(54) MOLDING APPARATUS AND METHOD FOR CONVEYING CONVEYANCE OBJECT

(75) Inventor: Satoshi OHGAMI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 12/176,051

(22) Filed: Jul. 18, 2008

Related U.S. Application Data
(63) Continuation of application No. PCT/JP07/50726, filed on Jan. 18, 2007.

(30) Foreign Application Priority Data
Jan. 19, 2006 (JP) 2006-010669

(51) Int. Cl. B29C 43/52

(52) U.S. Cl. 264/238; 425/161

(57) ABSTRACT

The invention provides a molding apparatus having: an outside-air-blocking conveying passageway allowing a conveyance object passing therethrough; and a chamber having a non-oxidizing gas atmosphere, the outside-air-blocking conveying passageway having a blocking member having restoring force, the blocking member touching the conveyance object passing through the outside-air-blocking conveying passageway, at least one of the inlet side and outlet side of the outside-air-blocking conveying passageway being blocked with the blocking member upon the conveyance object passing through the outside-air-blocking conveying passageway, the outside-air-blocking conveying passageway having an overall length longer than that of the conveyance object.

### TECHNICAL FIELD

The present invention relates to a molding apparatus for press-molding optical elements, e.g., glass lenses for use in optical instruments and to a method for conveying a conveyance object.

### BACKGROUND ART

A molding method has hitherto been practiced extensively in which a raw glass material which has been heated and softened is press-molded to produce an optical element comprising a glass lens. Namely, for example, a raw glass material preformed into a spherical shape is set in a mold constituted of an upper die, lower die, and barrel die, softened by heating to about 500-800° C. in a heating step, and then pressed and molded into a lens product and this product is cooled and then taken out.

Of those steps, the molding, in particular, is conducted at a high temperature. Because of this, in case where the molding is conducted in air, which contains oxygen, oxidation of the mold and mold-protective film proceeds, resulting in a shortened mold life. In particular, the molding surfaces of molds for use in forming the optical surfaces of lenses are high-precision mirror surfaces and are generally coated with a protective film. However, these molding surfaces, upon oxidation, become rough and exert an influence on the transmission and shape accuracy of the lens to be molded. Furthermore, there are cases where the mold surfaces or the surface of the raw glass material reacts with the oxygen in air to form oxides, and these oxides react with each other during press molding and adhere tenaciously, resulting in troubles that the molded article breaks and the molded article adheres to the mold and cannot be removed therefrom. When such a molded article which has adhered to the mold is forcibly removed, part of the raw glass material remains in the mold. For removing it without marring the mirror surface of the mold, it is necessary to conduct a treatment which, for example, comprises conducting careful polishing with an alumina powder or dissolving the glass in a solution of hydrofluoric acid, ammonium fluoride, or the like. In case where the mold is marred accidentally in this treatment, the molding surface should be subjected to coating again and this necessitates much labor and cost. Furthermore, in case where the mold has oxidized, the sliding parts of the upper die and barrel die have increased resistance and this results in a prolonged molding tact and the necessity of modifying the molding conditions. Stable mass-production hence becomes impossible.

For avoiding such troubles, it is necessary to fill the molding apparatus, which is heated to a high temperature, with a non-oxidizing gas such as, e.g., nitrogen gas or argon gas and maintain a non-oxidizing atmosphere in which oxygen does not come.

Hitherto, a molding apparatus has been equipped with a shutter at the inlet and outlet of the whole molding apparatus or of each of the heating, press molding, and cooling steps so as to prevent oxygen from coming into the molding apparatus in each of these steps when a raw material for an optical element or a mold containing the raw material set therein is conveyed into and led out from the molding apparatus.

For example, patent document 1 discloses a molding apparatus in which a mold is conveyed successively through a heating part, molding part, and cooling part. In this molding apparatus, a shutter type heat shield plate has been disposed between the steps. These step parts are disposed in a housing wholly filled with a non-oxidizing atmosphere and the heat shield plates are disposed for the purpose of preventing heat from escaping from each step. However, during shutter opening/closing operations, air or a gas flows in a relatively large amount through open parts of the shutters and heat also escapes together with it.

Patent document 2 discloses a molding apparatus in which a mold is disposed in a molding chamber and a raw material for an optical element is conveyed. This molding apparatus has a shutter on each side of the molding chamber. In this case also, a relatively large amount of air or a gas flows in through open parts of the shutters during shutter opening/closing operations, resulting in a considerable increase in oxygen concentration.

FIGS. 6(A) to 6(C) are views illustrating, in order, how a conveyance object 53, e.g., a mold or a raw material, passes through an opening side 50 having a shutter 52; (a) is plan views and (b) is front views.

As shown in FIG. 6(A), the opening side 50 is blocked with the shutter 52. When the conveyance object 53 is conveyed in the direction of the arrow and reaches a position just before the shutter 52, this is detected with, e.g., a sensor or the like and the shutter 52 ascends and opens as shown in FIG. 6(B). After the shutter 52 has fully opened, the conveyance object 53 passes through the opening side 50. At this time, the opening side 50 is in the state of being wholly open to the outside as shown in (b) of FIG. 6(B). After the conveyance object 53 has wholly entered the chamber 51, the shutter 52 is closed as shown in FIG. 6(C). Thus, the opening side 50 is kept wholly open to the outside throughout the period in which the conveyance object 53 is passing through the opening side 50. During this period, oxidizing gases including air flow in through the opening side 50 to increase the oxygen concentration in the chamber 51.

In patent document 2, a heating part, which has a highest temperature, is disposed in an inner part of the molding apparatus. However, it is unavoidable that a large amount of an oxidizing gas flows in through the opening when the conveyance object is conveyed in or out. Because of this, a non-oxidizing atmosphere is maintained by supplying nitrogen gas in a large amount to conduct gas replacement, which takes much time. This method, however, necessitates a large amount of nitrogen gas and the gas replacement requires much time. Production with this apparatus is hence costly and has reduced productivity.

There are cases where a preliminary chamber is disposed before and after a molding apparatus in order to reduce the amount of oxygen which flows into the molding apparatus during shutter opening/closing as described above. Namely, the inlet door of the preliminary chamber is first opened to convey a conveyance object into the preliminary chamber and, after the inlet door of the preliminary chamber is closed, the inlet door of a zone for conducting a step, e.g., a heating chamber, is opened to convey the conveyance object thereinto. According to this method, the heating chamber is prevented from becoming directly open to the outside and, hence, the amount of oxygen which flows in is reduced. However, oxygen flows into the preliminary chamber upon the opening of the inlet door of the preliminary chamber and this oxygen flows into the heating chamber upon the subsequent opening of the inlet door of the heating chamber. That method hence cannot sufficiently maintain a non-oxidizing atmosphere in the heating chamber. In addition, since a space for the preliminary chamber is necessary, the apparatus as a whole has an increased size.

### [Patent Document 1] JP-B-3-55417

### [Patent Document 2] JP-A-8-188421

### DISCLOSURE OF THE INVENTION

### Problems to be Resolved by the Invention

The invention has been achieved in view of the prior-art techniques described above. An object of the invention is to provide a molding apparatus and a method for conveying a conveyance object in each of which when a conveyance object such as a mold or a raw material is conveyed to the molding apparatus, oxygen is inhibited from flowing into the molding apparatus.

### Means of Solving the Problems

In order to accomplish the objects, the invention provides, in a first aspect thereof, a molding apparatus comprising: an outside-air-blocking conveying passageway allowing a conveyance object passing therethrough; and a chamber having a non-oxidizing gas atmosphere, the outside-air-blocking conveying passageway comprising a blocking member having restoring force, the blocking member touching the conveyance object passing through the outside-air-blocking conveying passageway, at least one of the inlet side and outlet side of the outside-air-blocking conveying passageway being blocked with the blocking member upon the conveyance object passing through the outside-air-blocking conveying passageway, the outside-air-blocking conveying passageway having an overall length longer than that of the conveyance object.

In a second aspect of the invention, the blocking member preferably comprises a plurality of gates each comprising a plurality of hanged members having a strip-form sheet or a plate member arranged in the same or approximately the same plane, and the gates are arranged along the lengthwise direction of the outside-air-blocking conveying passageway.

In a third aspect of the invention, at least one of the hanged members is preferably disposed so as to overlap a side edge part of an adjoining hanged member.

In a fourth aspect of the invention, the gate preferably comprises: a first hanged member located on the center side of the outside-air-blocking conveying passageway; and a second hanged member located on the outer side of the outside-air-blocking conveying passageway than the first hanged member, the first hanged member is disposed on the conveyance direction side of the conveyance object than the second hanged member.

In a fifth aspect of the invention, the blocking member preferably comprises an elastic body having a slit extending through the elastic body in the conveyance direction for the conveyance object.

In a sixth aspect of the invention, the blocking member preferably comprises a pair of rotatable cylindrical members each comprising an elastic body, the cylindrical members are disposed in a butt arrangement.

The invention further provides, in a seventh aspect thereof, a method for conveying a conveyance object in any one of the molding apparatus indicated above, the molding apparatus comprising: an outside-air-blocking conveying passageway allowing the conveyance object passing therethrough; and a chamber having a non-oxidizing gas atmosphere, the outside-air-blocking conveying passageway comprising a blocking member having restoring force, the blocking member touching the conveyance object passing through the outside-air-blocking conveying passageway, at least one of the inlet side and outlet side of the outside-air-blocking conveying passageway being blocked with the blocking member upon the conveyance object passing through the outside-air-blocking conveying passageway, the outside-air-blocking conveying passageway having an overall length in the conveyance direction longer than that of the conveyance object, the method comprising the conveyance object passing through the outside-air-blocking conveying passageway by allowing the conveyance object touching and push-opening the blocking member.

Incidentally, the term “outside-air-blocking conveying passageway” in the invention means a passageway part which, when disposed at least one of the inlet and outlet of a chamber, has the function of inhibiting/blocking the flowing of the outside air into the chamber.

### ADVANTAGEOUS EFFECTS OF THE INVENTION

According to the first aspect of the invention, a conveyance object, when it passes through the outside-air-blocking conveying passageway, touches the blocking member having restoring force and disposed in the outside-air-blocking conveying passageway. The conveyance object hence passes through the outside-air-blocking conveying passageway while pushing the blocking member open. Consequently, there is no need of opening the blocking member before a conveyance object is passed through, and an oxidizing gas can be prevented from flowing into the chamber. Furthermore, at the time when a conveyance object touches the blocking member and pushes it open on the inlet side of the outside-air-blocking conveying passageway, the outlet side of the blocking member is kept blocked. At the time when the conveyance object has moved to the outlet side of the outside-air-blocking conveying passageway, the inlet side is blocked due to the restoring force of the blocking member. Consequently, during the period when the conveyance object passes through the outside-air-blocking conveying passageway, at least one of the inlet side and outlet side of the outside-air-blocking conveying passageway is blocked with the blocking member. Because of this, the amount of an oxidizing gas which flows in can be considerably reduced and the oxygen concentration in the chamber can be kept low. As a result, the mold is inhibited from oxidizing, the mold and the mold-protective film have a prolonged life, and the frequency of maintenance is reduced. Therefore, costs including mold cost and labor cost can be reduced.

According to the second aspect of the invention, the blocking member is preferably constituted of a plurality of gates each composed of a plurality of hanged members comprising strip-form sheet or plate members arranged in the same or almost the same plane, the gates being arranged along the lengthwise direction for the outside-air-blocking conveying passageway. Because of this, the gates successively open as a conveyance object passes and the gates close due to their restoring force immediately after the conveyance object has passed. By arrangement two or more such gates, a structure can be obtained which always has one or more closed gates during the passing of the conveyance object. Consequently, an inlet or outlet which has no opening area and no open time (i.e., which always has a closed part) can be provided. The amount of an oxidizing gas which flows in can be considerably reduced and the oxygen concentration in the chamber can be kept low. Namely, no opening extending through the whole outside-air-blocking conveying passageway is formed because during the passing of a conveyance object, the gates arranged along the outside-air-blocking conveying passageway include at least one gate which is closed. Consequently, the outside-air-blocking conveying passageway can always retain the state in which a gate is closed, whereby an oxidizing gas can be prevented from coming in without fail.

According to the third aspect of the invention, at least one of the hanged members is preferably disposed so as to overlap a side edge part of an adjoining hanged member. This constitution can enhance the gas tightness of the chamber and prevent an oxidizing gas from flowing in through a gap between hanged members, whereby the oxygen concentration in the chamber can be kept low.

According to the fourth aspect of the invention, each gate preferably comprises a first hanged member located on the center side of the outside-air-blocking conveying passageway and a second hanged member located on the outer side of the outside-air-blocking conveying passageway more than the first hanged member, the first hanged member being disposed on the conveyance direction side of the conveyance object more than the second hanged member. Due to this, when a conveyance object passes through the gate, the center-side hanged member is lastly returned to the original position by restoring force. Consequently, even after the conveyance object has passed, the direction of overlapping of the hanged members can be maintained.

According to the fifth aspect of the invention, the blocking member preferably comprises an elastic body having a slit extending through the elastic body in the conveyance direction for the conveyance object. Due to this constitution, a conveyance object touches the blocking member and passes through the blocking member while pushing the slit open. After the conveyance object has thus passed, the slit closes due to the restoring force of the blocking member because the blocking member comprises an elastic body. Consequently, during the passing of the conveyance object, at least the inlet side or outlet side of the blocking member is blocked, whereby the amount of an oxidizing gas flowing in can be considerably reduced and the oxygen concentration in the chamber can be kept low.

According to the sixth aspect of the invention, the blocking member preferably comprises a pair of rotatable cylindrical members each comprising an elastic body, the cylindrical members being disposed in a butt arrangement. Due to this constitution, a conveyance object touches the blocking member and passes through the blocking member while pushing the butt-arranged parts open. As the conveyance object thus passes, the cylindrical members rotate because they are rotatable and the butt-arranged parts close due to the restoring force of the elastic body. Consequently, during the passing of the conveyance object, at least the inlet side or outlet side of the blocking member is blocked, whereby the amount of an oxidizing gas flowing in can be considerably reduced and the oxygen concentration in the chamber can be kept low.

According to the seventh aspect of the invention, a conveyance object touches the blocking member disposed in the outside-air-blocking conveying passageway and having restoring force and passes through the outside-air-blocking conveying passageway while pushing the blocking member open. Consequently, there is no need of opening the blocking member before a conveyance object is passed, and an oxidizing gas can be prevented from flowing into the chamber. Furthermore, at the time when a conveyance object touches the blocking member and pushes it open on the inlet side of the outside-air-blocking conveying passageway, the outlet side of the blocking member is kept blocked. At the time when the conveyance object has moved to the outlet side of the outside-air-blocking conveying passageway, the inlet side is blocked due to the restoring force of the blocking member. Consequently, during the period when the conveyance object passes through the outside-air-blocking conveying passageway, at least one of the inlet side and outlet side of the outside-air-blocking conveying passageway is blocked with the blocking member. Because of this, the amount of an oxidizing gas which flows in can be considerably reduced and the oxygen concentration in the chamber can be kept low. As a result, the mold is inhibited from oxidizing, the mold and the mold-protective film have a prolonged life, and the frequency of maintenance is reduced. Therefore, costs including mold cost and labor cost can be reduced. In addition, neither a sensor for detecting a conveyance object nor a driving force for door opening/closing is necessary, and the cost of installation and operation is low. Therefore, the total cost necessary for producing an optical element can be considerably reduced.

### BRIEF DESCRIPTION OF THE DRAWINGS

FIGS. 1(A) to 1(D) are diagrammatic views of an important part of a molding apparatus according to the invention.

FIG. 2 is a diagrammatic view illustrating an example of a conveyance object in the conveyance of a mold comprising an upper die, lower die, and barrel die.

FIGS. 3(A) to 3(D) are diagrammatic views of another molding apparatus according to the invention.

FIGS. 4(A) to 4(D) are diagrammatic views of still another molding apparatus according to the invention.

FIGS. 5(A) to 5(C) are diagrammatic views of a further molding apparatus according to the invention.

FIGS. 6(A) to 6(C) are views illustrating an example of related-art techniques.

FIG. 7 is a diagrammatic overall view of a molding apparatus according to the invention.

### DESCRIPTION OF THE REFERENCE NUMERALS AND SIGNS

1: chamber
2: outside-air-blocking conveying passageway
3, 3a-3c: hanged member
4: gate
5: conveyance object
6: inside of chamber
7: elastic body
8: slit
9: cylindrical body
10: shaft
30: mold
30a: upper die
30b: lower die
30c: barrel die
31: optical element
32: cover
33: conveying means
40: molding apparatus
50: opening side
51: inside of chamber
52: shutter
53: conveyance object

### BEST MODE FOR CARRYING OUT THE INVENTION

In the case where the molding apparatus according to the invention is applied to a molding apparatus for molding an optical element, e.g., a glass lens, a raw material or a molded article is conveyed, in the state of being placed in a mold or in the state of being placed on a holder or the like after having been taken out of the mold, to places where the steps of heating, molding, and cooling are respectively conducted. In the heating step, the mold or the raw glass material is heated to a temperature at which the raw material softens and can be press-molded. In the molding step, the raw material heated is pressed to mold a product having given dimensions while optionally continuing heating in order that the temperature of the raw material does not decline. In the cooling step, the molded article is cooled to an appropriate temperature at which the quality of the molded article becomes stable.

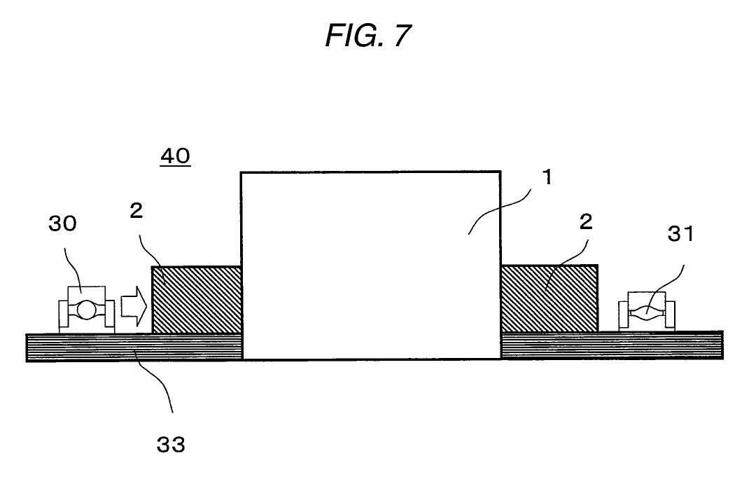

FIG. 7 shows a diagrammatic overall view of one embodiment of the molding apparatus according to the invention. The molding apparatus 40 in FIG. 7 has a chamber 1 and outside-air-blocking conveying passageways 2 disposed on the inlet side and outlet side thereof. A mold 30 is moved from the left to the right in the figure with a conveying means 33. Preferred examples of the conveying means 33 include a belt conveyer.

In this embodiment, at least a molding step is conducted in the chamber 1. In the case where the molding apparatus according to the invention is applied to a molding apparatus for molding an optical element, e.g., a glass lens, it is preferred that steps other than the molding step (e.g., a heating step, cooling step, etc.) also be conducted in the chamber 1 from the standpoint of stabilizing the quality of the optical element 31 as a molded article.

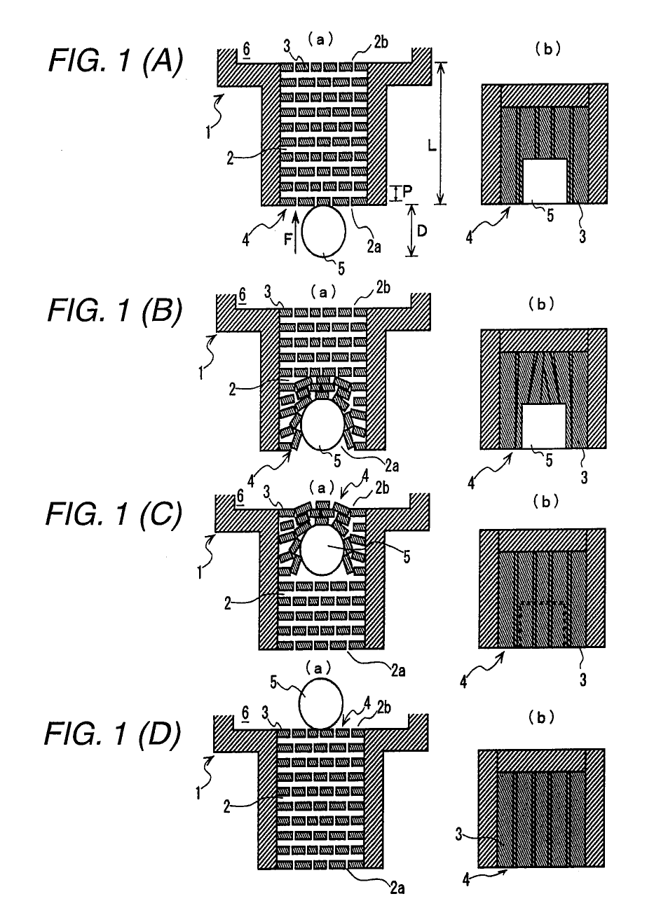

FIGS. 1(A) to 1(D) are diagrammatic views of an important part of one embodiment of the molding apparatus according to the invention. In each of FIGS. 1(A) to 1(D), (a) is plan views of the embodiment viewed from above, and (b) is front views thereof. Furthermore, FIGS. 1(A) to 1(D) are views illustrating, in order, the state in which a conveyance object is passing through an outside-air-blocking conveying passageway.

As shown in the figure, gates 4 (ten gates in the figure) each constituted of hanged members 3 (five or six hanged members in the figure) are arranged at the same interval P in the overall length L of the outside-air-blocking conveying passageway 2 extending from the inlet side 2a to the outlet side 2b. Namely, the molding apparatus 1 according to the invention has an outside-air-blocking conveying passageway 2 equipped with such gates 4 each constituted of hanged members 3. These gates 4 block the outside-air-blocking conveying passageway 2 to block the flowing of air into the chamber 6. The gates 4 have been formed so that the positions of the boundaries between adjoining hanged members 3 differ from gate 4 to gate 4 each other, in order to heighten the gas tightness of the chamber 6. The hanged members 3 comprise strip-form sheet or plate members, and are hanged from the ceiling of the side walls of the outside-air-blocking conveying passageway 2. The material of the hanged members 3 preferably is one which is excellent in flexibility and gas tightness. For example, sheets or thin plates made of a resin or sheets of a metal, e.g., iron or stainless steel, are used. Metal sheets are preferred for use in places where heat resistance is especially required. Rigid platy members having no flexibility may be used by attaching them to the ceiling of the side walls with hinges or the like. Incidentally, in the case where platy members or the like are attached, they may be attached in horizontal directions, e.g., on both of the left and right sides. Furthermore, a mixed arrangement may be used in which part of the members are vertically attached like the hanged members 3 and others are horizontally attached.

In FIGS. 1(A) to 1(D), a sheet made of a resin and having a thickness of 0.2 mm is slit and bonded to the ceiling of the inlet having an aperture of 40 mm×40 mm, and ten such slit sheets are arranged as gates 4 at the same interval P. For the purpose of enhancing gas tightness, the gates 4 alternately have 6 hanged members and 5 hanged members so that any two adjoining gates differ in the positions of the slits. The conveyance member 5 is in a cylindrical form of Φ30 mm×30 mm, and a belt conveyer is used for conveyance.

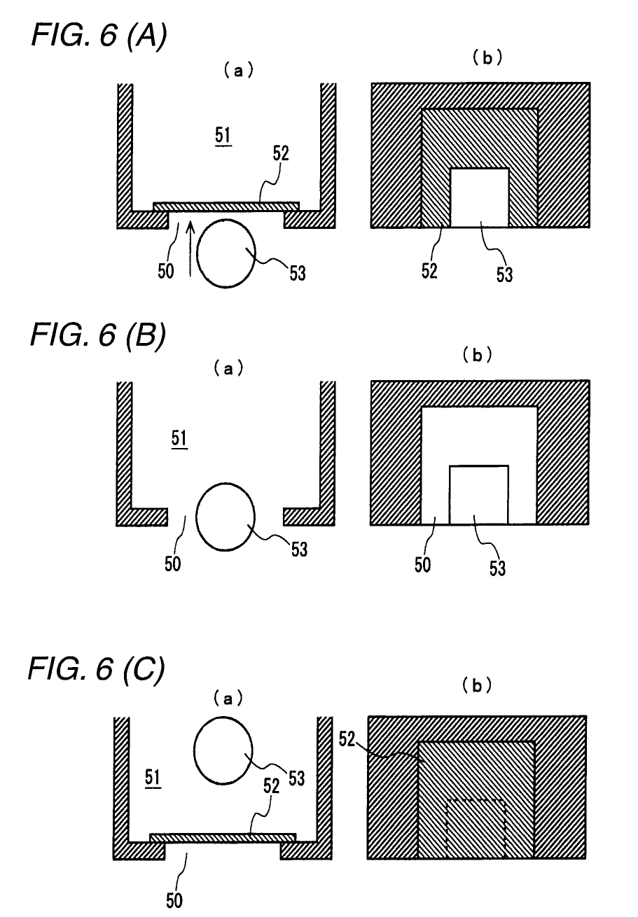

In the case where the molding apparatus 1 according to the invention is used to convey the conveyance object 5, the conveyance is as follows. As shown in FIG. 1(A), the conveyance object 5 is conveyed in the direction of arrow F, approaches the inlet side 2a of the outside-air-blocking conveying passageway 2, and touches a gate 4. As the conveyance object 5 passes through the passageway 2, gates 4 are successively pushed open by the conveyance object 5 as shown in FIG. 1(B). As the conveyance object 5 further proceeds, the conveyance object 5 approaches the outlet side 2b of the outside-air-blocking conveying passageway 2 as shown in FIG. 1(C), and the gate 4 on the outlet side 2b is pushed open. The gate 4 on the inlet side 2a returns to the original position due to restoring force. The restoring force in this case is obtained when the hanged members 3 pushed and spread inward by the conveyance object 5 return again to the original positions by means of their own weight. Thus, only the hanged members 3 located in the part where the conveyance object 5 is passing are opened with the passing of the conveyance object 5. Consequently, compared to the case employing the shutter 52 in FIGS. 6(A) to 6(C) described above, the amount of oxygen which flows in can be significantly reduced. Thereafter, the conveyance object 5 is conveyed to the chamber inside 6 as shown in FIG. 1(D) and subjected to a molding treatment in the chamber 1.

Due to the constitution described above, when the conveyance object 5 passes through the outside-air-blocking conveying passageway 2, the gates 4 always include one or more gates which are closed. Namely, the passageway 2 can always retain the state in which at least one of the gates 4 on the inlet side 2a and outlet side 2b of the conveyance object 5 is closed due to the restoring force of the gates 4. Consequently, the amount of an oxidizing gas which flows in can be considerably reduced and the oxygen concentration in the molding apparatus can be kept low. Thus, the outside-air-blocking conveying passageway 2 can always retain the state in which a gate 4 in any position is closed, and the flowing of an oxidizing gas into the chamber inside 6 can be prevented without fail.

Actually, the increase in oxygen concentration in the chamber inside 6 resulting from the conveyance of the conveyance object 5 using the outside-air-blocking conveying passageway of the invention decreased to about 1/20 the increase in the case of using the shutter opening/closing shown in FIGS. 6(A) to 6(C) described above. Although FIGS. 1(A) to 1(D) show the case in which a conveyance object 5 is conveyed from the outside having an oxidizing gas atmosphere to the chamber inside 6 having a non-oxidizing gas atmosphere, the outside-air-blocking conveying passageway of the invention is applicable to the reverse case in which a conveyance object 5 is conveyed from the chamber inside to the outside. Furthermore, the outside-air-blocking conveying passageway of the invention is applicable also to a partition between the steps of heating, molding, and cooling disposed in a non-oxidizing gas atmosphere. In this case, an influence of temperature on other steps can be lessened.

For preventing the gates 4 on the inlet side 2a and outlet side 2b from being simultaneously opened, it is preferred that the ratio of the overall length L to the conveyance-direction length D of the conveyance object 5 (L/D) be 1.2 or higher. In FIGS. 1(A) to 1(D), that ratio is 2.25. Namely, the overall length L of the outside-air-blocking conveying passageway 2 is larger than the conveyance-direction length D of the conveyance object 5. Furthermore, the interval P between the gates 4 preferably is such that D/P is 0.1 to 10 so that the hanged members 3 are prevented from coming into contact and intertwining with one another or from imposing an unnecessary load on the conveyance object 5 when the conveyance object 5 passes. FIGS. 1(A) to 1(D) show the case where that ratio is 4.

Furthermore, by elevating the pressure in the chamber inside 6 to above atmospheric pressure, oxygen can be prevented from flowing into the chamber inside 6 from the atmosphere, i.e., from the inlet side 2a of the outside-air-blocking conveying passageway 2.

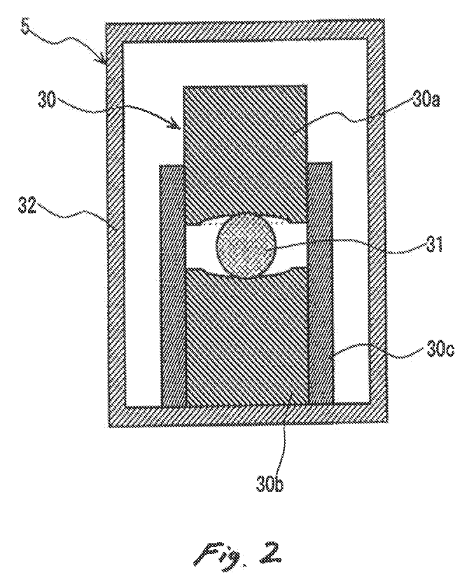

FIG. 2 shows an example of a conveyance object in the conveyance of a mold comprising an upper die, lower die, and barrel die. A mold 30 is formed by slidably fitting an upper die 30a and a lower die 30b into a cylindrical barrel die 30c. Before molding, the upper end of the upper die 30a is located above the upper end of the barrel die 30c as shown in the figure. In case where the mold having this shape pushes hanged members 3 open, the hanged members 3 come into contact with the upper die 30a to finely vibrate the upper die 30a and this may form fine mars in that part the optical element 31 which is in contact with the upper die 30a. In such cases, the mold 30 is covered with a cylindrical or rectangular cover 32 and conveyed in this state, whereby the upper die 30a of the mold 30 does not come into contact with the hanged members 3 and, hence, the optical element 31 can be prevented from receiving fine mars.

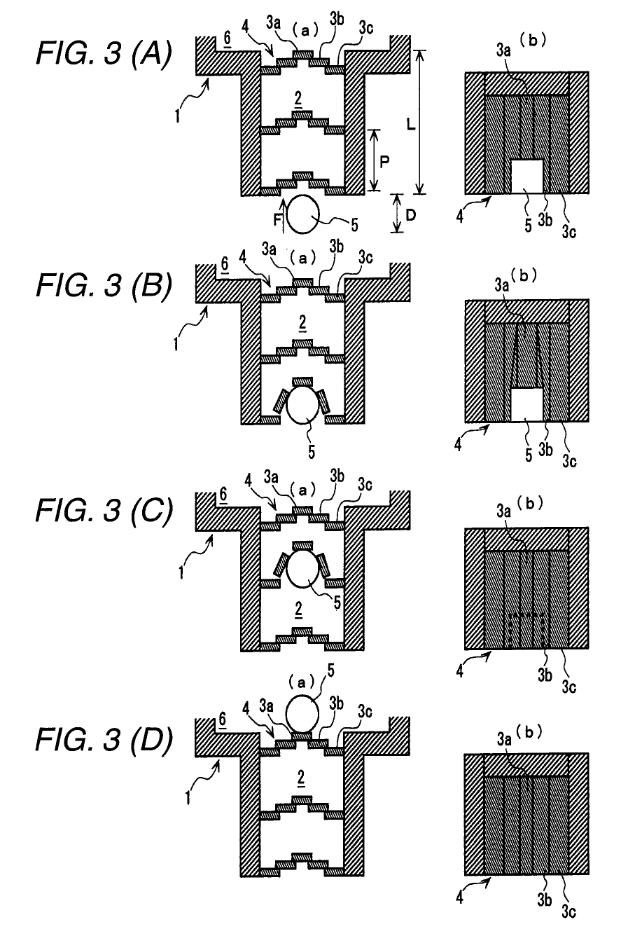

FIGS. 3(A) to 3(D) are diagrammatic views of another embodiment of the molding apparatus according to the invention. In each of FIGS. 3(A) to 3(D), (a) is plan views of the embodiment viewed from above, and (b) is front views thereof. Furthermore, FIGS. 3(A) to 3(D) are views illustrating, in order, the state in which a conveyance object is passing through an outside-air-blocking conveying passageway, like FIGS. 1(A) to 1(D).

As shown in the figure, the hanged members 3 (3a to 3c) are disposed so that each of these overlaps a side edge of an adjoining hanged member 3. This enhances the gas tightness of the outside-air-blocking conveying passageway 2 and prevents an oxidizing gas from flowing in through a gap between hanged members 3, whereby the oxygen concentration in the molding apparatus 1 can be kept low. Furthermore, the gates 4 are formed by successively arranging hanged members so that a hanged member located on the center side of the outside-air-blocking conveying passageway 2 is disposed on the conveyance direction side of a conveyance object than a hanged member located on the outer side of the outside-air-blocking conveying passageway more than that hanged member. Namely, hanged members 3 are first disposed by both side walls of the outside-air-blocking conveying passageway 2 and hanged members 3 are then formed in order toward the chamber side in an overlap arrangement so that the hanged member 3 located on the center side of the outside-air-blocking conveying passageway 2 is formed so as to be located nearest to the chamber in the conveyance direction. Due to this, when a conveyance object 5 passes through each gate 4, the center-side hanged member 3 is lastly returned to the original position by restoring force. Consequently, even after the conveyance object has passed, the direction of overlapping of the hanged members can be maintained.

FIGS. 3(A) to 3(D) show the case in which each gate 4 is constituted using five hanged members 3. Namely, the hanged members 3b located on the center side more than the hanged members 3c disposed by the side walls of the outside-air-blocking conveying passageway 2 are disposed so as to overlap on the chamber side in the conveyance direction, and the hanged member 3a located on the center side more than the hanged members 3b is disposed so as to overlap further on the chamber side. Due to this constitution, when a conveyance object 5 passes through each gate 4, the hanged members 3b are returned to the original positions by restoring force earlier than the hanged member 3a. There is hence no possibility that the direction of overlapping of the hanged members might change.

In FIGS. 3(A) to 3(D), the ratio of the overall length L of the outside-air-blocking conveying passageway 2 to the length D of the conveyance object 5, L/D, is 3.25. Namely, the overall length of the outside-air-blocking conveying passageway 2 is larger than in the case shown in FIGS. 1(A) to 1(D). Increasing the overall length L to such a degree is preferred because the gas in a conveyance object (e.g., the gas in the mold 30 shown in FIG. 2) can be replaced with a non-oxidizing gas during the period in which the conveyance object 5 moves through the outside-air-blocking conveying passageway 2. Especially when the conveyance path or conveyance period is long or when the time necessary for replacing the gas in the mold cannot be secured in other places, it is preferred to employ that constitution. Furthermore, such a large overall length L is preferred from the standpoints of maintenance and cost because even when the interval P between the gates is large, oxygen is less apt to flow into the chamber inside 6 from the outside air. In this case, the ratio of the length D of the conveyance object 5 to the interval P between the gates (D/P) is 1 or smaller.

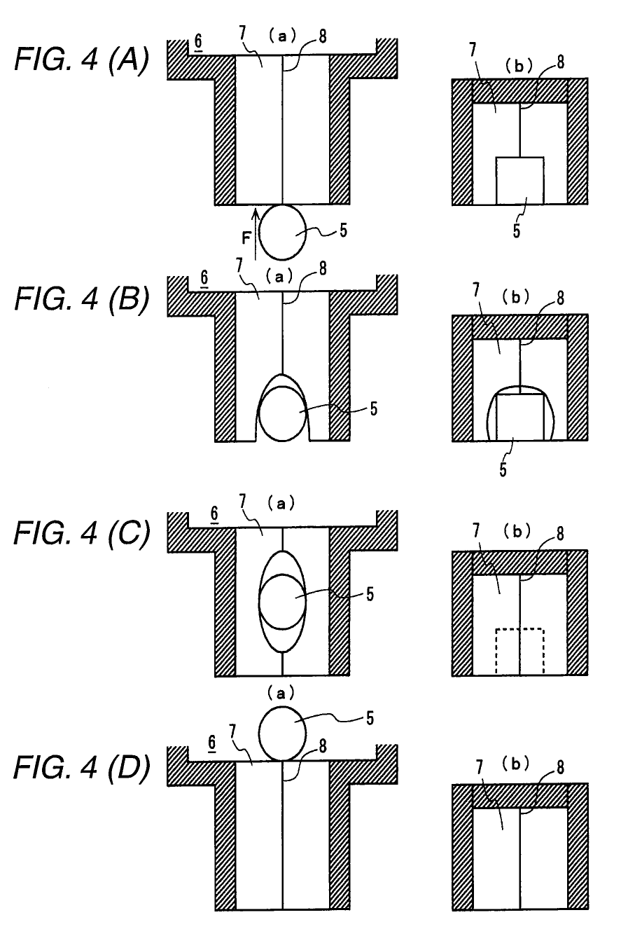

FIGS. 4(A) to 4(D) are diagrammatic views of still another embodiment of the molding apparatus according to the invention. In each of FIGS. 4(A) to 4(D), (a) is plan views of the embodiment viewed from above, and (b) is front views thereof. Furthermore, FIGS. 4(A) to 4(D) are views illustrating, in order, the state in which a conveyance object is passing through an outside-air-blocking conveying passageway, like FIGS. 1(A) to 1(D).

As shown in the figure, an elastic body 7 having a slit 8 extending therethrough in the conveyance direction for a conveyance object 5 is used as the blocking member which blocks the outside-air-blocking conveying passageway 2. The state in which a conveyance object 5 passes in this case is explained in order. First, as shown in FIG. 4(A), the conveyance object 5 is conveyed in the direction of arrow F and touches the elastic body 7. This conveyance object 5 pushes the slit 8 of the elastic body 7 open and enters the elastic body 7 as shown in FIG. 4(B). As the conveyance object 5 further proceeds and reaches around the center of the elastic body 7, the inlet side of the elastic body 7 through which the conveyance object 5 has passed is closed by the restoring force attributable to elasticity. Due to this restoring force, only that part of the slit 8 in the elastic body 7 through which the conveyance object 5 is passing is pushed open as the conveyance object 5 passes. Namely, during the passing of the conveyance object 5, at least the inlet side or outlet side of the elastic body 7 is blocked. Consequently, compared to the case employing the shutter 52 in FIGS. 6(A) to 6(C) described above, the amount of oxygen which flows in can be significantly reduced. Thereafter, the conveyance object 5 is conveyed to the chamber inside 6 as shown in FIG. 4(D) and subjected to a molding treatment in the molding apparatus 1. The elastic body 7 to be used in this case preferably is one made of a material which is flexible in such a degree that the elastic body is pushed open as the conveyance object 5 passes. Although the elastic body 7 may have voids, it is preferred that the voids are not interconnected and the elastic body as a whole has gas tightness. For example, use can be made of a sponge, a rubber, another foamed resin or elastic resin material, or the like.

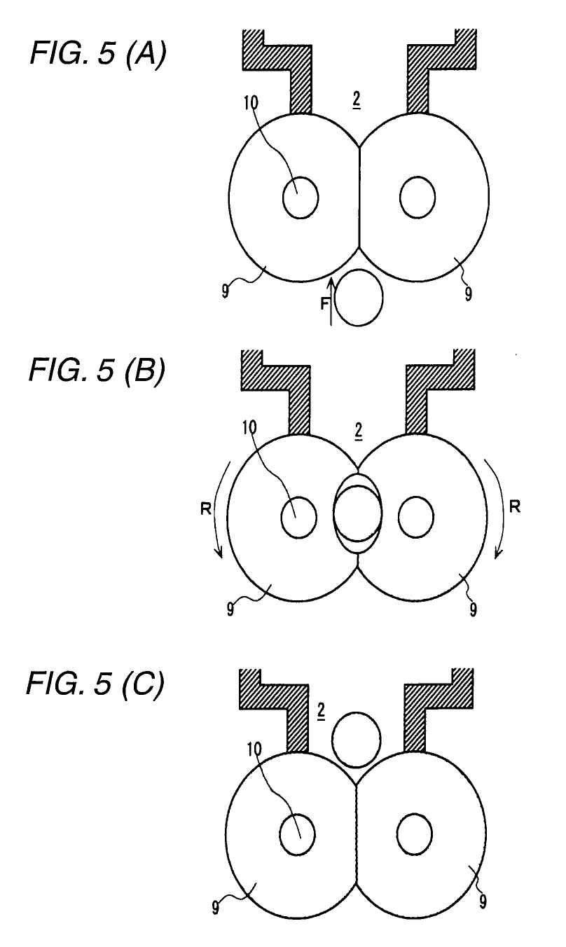

FIGS. 5(A) to 5(C) are diagrammatic views of a further embodiment of the molding apparatus according to the invention. Furthermore, FIGS. 5(A) to 5(C) show, in order, the state in which a conveyance object is passing through an outside-air-blocking conveying passageway.

As shown in the figure, a pair of cylindrical members 9 which each comprise an elastic body and are rotatable on a shaft 10 and which are disposed in a butt arrangement is used as the blocking member which blocks the outside-air-blocking conveying passageway 2. The state in which a conveyance object 5 passes in this case is explained in order. First, as shown in FIG. 5(A), the conveyance object 5 is conveyed in the direction of arrow F and touches the butt-arranged parts of the cylindrical members 9. This conveyance object 5 pushes the butt boundary between the cylindrical members 9 open, rotates the cylindrical members 9 in the directions of arrows R, and passes through the butt boundary between the cylindrical members 9 as shown in FIG. 5(B). In this passing, the conveyance object 5 inlet side of the butt boundary between the cylindrical members 9 is blocked due to the rotation of the cylindrical members 9. Namely, during the passing of the conveyance object 5, at least the inlet side or outlet side of the butt boundary between the cylindrical members 9 is blocked. Consequently, compared to the case employing the shutter 52 in FIGS. 6(A) to 6(C) described above, the amount of oxygen which flows in can be significantly reduced. Thereafter, the conveyance object 5 is conveyed to the chamber inside 6 as shown in FIG. 5(C) and subjected to a molding treatment in the molding apparatus 1. The cylindrical members 9 to be used in this case may be ones made of the same material as the elastic body 7 in FIGS. 4(A) to 4(D).

While the present invention has been described in detail and with reference to specific embodiments thereof, it will be apparent to one skilled in the art that various changes and modifications can be made therein without departing from the spirit and scope thereof.

The present application is based on Japanese Patent Application No. 2006-010669 filed on Jan. 19, 2006, and the contents thereof are incorporated herein by reference.

1. A molding apparatus comprising: an outside-air-blocking conveying passageway allowing a conveyance object passing therethrough; and a chamber having a non-oxidizing gas atmosphere,
the outside-air-blocking conveying passageway comprising a blocking member having restoring force,
the blocking member touching the conveyance object passing through the outside-air-blocking conveying passageway,
at least one of the inlet side and outlet side of the outside-air-blocking conveying passageway being blocked with the blocking member upon the conveyance object passing through the outside-air-blocking conveying passageway,
the outside-air-blocking conveying passageway having an overall length longer than that of the conveyance object.

2. The molding apparatus according to claim 1,
wherein the blocking member comprises a plurality of gates each comprising a plurality of hanged members having a strip-form sheet or a plate member arranged in the same or approximately the same plane, the gates are arranged along the lengthwise direction of the outside-air-blocking conveying passageway.

3. The molding apparatus according to claim 2,
wherein at least one of the hanged members is disposed so as to overlap a side edge part of an adjoining hanged member.

4. The molding apparatus according to claim 3,
wherein the gate comprises: a first hanged member located on the center side of the outside-air-blocking conveying passageway; and a second hanged member located on the outer side of the outside-air-blocking conveying passageway than the first hanged member, the first hanged member is disposed on the conveyance direction side of the conveyance object than the second hanged member.

5. The molding apparatus according to claim 1,
wherein the blocking member comprises an elastic body having a slit extending through the elastic body in the conveyance direction for the conveyance object.

6. The molding apparatus according to claim 1,
wherein the blocking member comprises a pair of rotatable cylindrical members each comprising an elastic body, the cylindrical members are disposed in a butt arrangement.

7. A method for conveying a conveyance object in the molding apparatus according to any one of claims 1 to 6,
the molding apparatus comprising: an outside-air-blocking conveying passageway allowing the conveyance object passing therethrough; and a chamber having a non-oxidizing gas atmosphere, the outside-air-blocking conveying passageway comprising a blocking member having restoring force, the blocking member touching the conveyance object passing through the outside-air-blocking conveying passageway, at least one of the inlet side and outlet side of the outside-air-blocking conveying passageway being blocked with the blocking member upon the conveyance object passing through the outside-air-blocking conveying passageway, the outside-air-blocking conveying passageway having an overall length longer than that of the conveyance object,
the method comprising the conveyance object passing through the outside-air-blocking conveying passageway by allowing the conveyance object touching and push-opening the blocking member.
